(19) United States
(12) Patent Application Publication
(10) Pub. No.: US 2024/0039069 A1
(43) Pub. Date: Feb. 1, 2024

(54) METHOD FOR TREATING SCRAPPED POSITIVE ELECTRODE SLURRY, AND APPLICATION

(71) Applicants: GUANGDONG BRUNP RECYCLING TECHNOLOGY CO., LTD., Foshan, Guangdong (CN); HUNAN BRUNP RECYCLING TECHNOLOGY CO., LTD., Changsha, Hunan (CN); HUNAN BRUNP VEHICLES RECYCLING CO., LTD., Changsha, Hunan (CN)

(72) Inventors: Qiang LI, Foshan, Guangdong (CN); Changdong LI, Foshan, Guangdong (CN); Dingshan RUAN, Foshan, Guangdong (CN); You ZHOU, Foshan, Guangdong (CN); Song CHEN, Foshan, Guangdong (CN); Peichao NING, Foshan, Guangdong (CN)

(73) Assignees: GUANGDONG BRUNP RECYCLING TECHNOLOGY CO., LTD., Foshan, Guangdong (CN); HUNAN BRUNP RECYCLING TECHNOLOGY CO., LTD., Changsha, Hunan (CN); HUNAN BRUNP VEHICLES RECYCLING CO., LTD., Changsha, Hunan (CN)

(21) Appl. No.: 18/265,377

(22) PCT Filed: Dec. 30, 2021
(86) PCT No.: PCT/CN2021/142947

§ 371 Date: Jun. 5, 2023

(30) Foreign Application Priority Data
Jun. 22, 2021 (CN) 202110693114.9

(51) Int. Cl. H01M 10/54; C22B 1/24; C22B 3/22; C22B 7/00; C22B 23/02

(52) U.S. Cl. CPC H01M 10/54; C22B 1/24; C22B 3/22; C22B 7/001; C22B 23/021

(57) ABSTRACT

A treatment method of scrapped positive electrode slurry, includes the following steps: pretreating the scrapped positive electrode slurry to obtain a slurry solution; performing electrophoresis coagulation and filter pressing on the slurry solution to obtain a liquid phase and a solid phase; and performing gradient roasting on the solid phase to obtain a positive electrode material.

### CROSS-REFERENCE TO RELATED APPLICATION

This application is a national stage filing under 35 U.S.C. § 371 of international application number PCT/CN2021/142947, filed Dec. 30, 2021, which claims priority to Chinese patent application No. 202110693114.9 filed Jun. 22, 2021. The contents of these applications are incorporated herein by reference in their entirety.

### TECHNICAL FIELD

The present disclosure belongs to the technical field of recycling of waste batteries, and particularly relates to a treatment method and application of scrapped positive electrode slurry.

### BACKGROUND

The lithium ion battery positive electrode slurry is composed of a positive electrode material, a binder and the like. Preparation of the positive electrode slurry is an important link of lithium ion battery production, and the preparation process thereof includes mutual mixing, dissolving, dispersing and the like between liquid and liquid and between liquid and the positive electrode material. The quality and the performance of the lithium ion battery are directly influenced by the dispersion quality of the slurry.

In recent years, along with stable increase of market demands of new energy automobiles, the production capacity of lithium ion batteries is continuously expanded. A large amount of scrapped positive electrode slurry appears in the production process, and its composition is a solid-liquid mixture. The main component of the solid phase is lithium nickel cobalt manganate, and the main component of the liquid phase is N-methyl pyrrolidone (hereinafter referred to as NMP). If the treatment is improper, not only is resource waste caused, but also environmental pollution is caused. Therefore, recycling scrapped positive electrode slurry has important significance in reducing environmental pollution, recycling NMP and relieving the shortage of cobalt and nickel resources.

An existing publicly reported method for treating scrapped positive electrode slurry mainly includes NMP regeneration and recycling of valuable metals, wherein liquid-solid separation is a key step in the recycling process. At present, a flocculation-filtration method, a centrifugal separation method and a distillation roasting method are mainly used to separate an NMP solution and a positive electrode material.

The related art discloses a recycling system of lithium battery positive electrode waste slurry, which adopts a centrifugal machine for liquid-solid separation. The solid phase is a positive electrode material, and the liquid phase is an NMP solution. The solid phase is calcined at 300-600° C., and then is crushed and leached in acid, so that the objective of recycling valuable metals is achieved. The liquid phase is dewatered at 80-100° C. by adopting the distillation process to obtain NMP. The positive electrode slurry has the characteristics of high viscosity, no coagulation, fine particles and the like. According to the related art, solid-liquid separation is performed by adopting a centrifuging method, the separation efficiency is low, the equipment loss is large, and the residual amount of NMP in the produced solid phase is high; in the subsequent roasting process, the hardening phenomenon is serious, and the wall adhesion is high, so that the conditions of unsmooth material conveying, incomplete removal of organic matters, serious corrosion of roasting equipment and the like are likely to be caused, and the method is not suitable for industrial production. There is a large amount of black powder suspension matter in the liquid phase, and some black powder remains in NMP in the distillation process, so that the recycling rate of valuable metals is reduced, and the product quality is seriously influenced.

At present, a method for recycling N-methyl pyrrolidone in the lithium battery positive electrode waste liquid is also disclosed in related art, which includes the steps of flocculating the waste liquid by using a flocculating agent, adding diatomite into sediment, and performing filter pressing to separate filtrate and filter residue; and finally obtaining an NMP solution and a positive electrode material. The related art only pays attention to the recycling of NMP organic matter, adopts a method of combining a flocculating agent and diatomite for solid-liquid separation, introduces diatomite impurities into solid products, and increases the recycling difficulty of valuable metals nickel and cobalt.

### SUMMARY

The present disclosure aims to solve at least one of the above technical problems in the current technology. Therefore, the present disclosure provides a treatment method and application of scrapped positive electrode slurry. The method takes the scrapped positive electrode slurry as a raw material, recycles the scrapped positive electrode slurry by utilizing processes of crushing and sorting, electrophoresis and gradient roasting, does not need to introduce a flocculating agent, has the advantages of thorough separation of an NMP solution and positive electrode powder, high recycling rate of organic matter and valuable metals, high production efficiency and the like, not only improves economic benefits, but also reduces environmental pollution.

In order to realize the objectives, the present disclosure adopts the following technical solution:

A treatment method of scrapped positive electrode slurry, comprising the following steps:
(1) pretreating the scrapped positive electrode slurry to obtain a slurry solution;
(2) performing electrophoresis coagulation and filter pressing on the slurry solution to obtain a liquid phase and a solid phase; and
(3) performing gradient roasting on the solid phase to obtain a positive electrode material.

Preferably, the pretreatment in the step (1) includes the specific steps: separating out bagged materials from the scrapped positive electrode slurry, and crushing and sorting the bagged materials to obtain the slurry solution.

The bagged materials are crushed and sorted to remove plastic and blocky impurities in the bagged materials. One is to ensure smooth conveying of the materials, in other words, positive electrode powder in the slurry is micron particles, liquid is the NMP solution, and when plastic bags and blocky impurities exist in a system, the material conveying process is extremely likely to jam. Two is to ensure uniformity of solid materials and to remove plastic bags and the blocky impurities in the solid materials, and the influence of impurities on the subsequent treatment process of the positive electrode powder is reduced. If plastic impurities exist, the phenomenon of melting and rolling will occur in a heat treatment step, causing that the positive electrode powder is wrapped, and affecting the recycling rate of products.

Preferably, a direct current used in the process of performing electrophoresis coagulation in the step (2) has a current of 50-70 mA and a voltage of 60-65 V.

More preferably, the direct current used in the process of performing electrophoresis coagulation in the step (2) has a current density of 0.2-0.6 A/m².

Preferably, time of the electrophoresis in the step (2) is 20-60 min.

According to the electrophoresis principle, the direct current is introduced into the slurry solution, suspended particles in the slurry solution are directionally moved under the action of an external direct current electric field to be combined into large particle coagulation, and liquid-solid separation is performed by using a filter press to obtain the liquid phase which is an NMP aqueous solution and the solid phase which is a solid material. The positive electrode material in the positive electrode slurry is coagulated through the electrophoresis without using a flocculating agent, and introduction of impurities is reduced.

Preferably, the step (2) further includes performing distillation on the liquid phase, and enriching an organic phase to obtain NMP with a purity larger than 70%.

Further preferably, the distillation is reduced pressure rotary evaporation or rectification.

More preferably, the gauge pressure of the reduced pressure rotary evaporation is 0.02-0.04 MPa, the temperature of the reduced pressure rotary evaporation is 60-80° C., and the time of the reduced pressure rotary evaporation is 60-80 min.

Further preferably, when the distillation is the rectification, organic phases are enriched, and the purity of obtained NMP is larger than 99%.

More preferably, the conditions of the rectification are that pH of the liquid phase is 7.0-10.0, pressure of an evaporation pot is 7.5-8.0 kPa, and a reflux ratio is 2-2.5.

Preferably, a specific process of the gradient roasting in the step (3) is roasting the solid phase at three stages, wherein first-stage roasting is performed at 80-100° C. for 20-60 min, second-stage roasting is performed at 200-250° C. for 30-60 min, and third-stage roasting is performed at 350-450° C. for 30-60 min, so as to obtain the positive electrode material.

Further preferably, the method further includes after the second-stage roasting, condensing gas obtained by roasting, and recovering NMP.

More preferably, the temperature of the condensation is 25-35° C.

The temperature of the first-stage roasting is 80-100° C. for removing most of water in the solid phase. The temperature of the second-stage roasting is 200-250° C. for removing NMP remained in the solid phase. Meanwhile, the condensation step is added, to condense and recycle the NMP. The temperature of the third-stage roasting is 350-450° C., and a binder PVDF (thermal decomposition temperature 316° C.) in the solid phase is removed at this stage. Finally, the positive electrode material without organic components is obtained and can be directly used for leaching and recycling valuable metals.

The present disclosure provides application of the above method in recycling valuable metals.

Preferably, the application in recycling valuable metals is performing further leaching and ageing treatment on the positive electrode material obtained by the above method to obtain the valuable metals.

The specific principle is as follows: the present disclosure recycles the scrapped positive electrode slurry by creatively combining the crushing, sorting, electrophoresis and gradient roasting processes, and has a great industrial application prospect. Firstly, plastic and blocky impurities are removed through crushing and sorting to obtain a slurry solution; secondly, suspension matter is coagulated by adopting an electrophoresis method, and filter pressing is performed to obtain a liquid phase and a solid phase; thirdly, the liquid phase is rectified or distilled to obtain an NMP organic phase and an aqueous phase; and fourthly, a gradient roasting process is adopted to remove moisture and a binder and recycle NMP, and the positive electrode material is obtained.

Compared with the current technology, the present disclosure has the following beneficial effects:
1. The method of the present disclosure takes the scrapped positive electrode slurry as a raw material, recycles the scrapped positive electrode slurry by utilizing crushing, sorting, electrophoresis and gradient roasting processes, does not need to introduce a flocculating agent, has the advantages of thorough separation of an NMP solution and positive electrode powder, high recycling rate up to 95% of organic matter and valuable metals, high production efficiency and the like, not only improves economic benefits, but also reduces environmental pollution.
2. The present disclosure changes the characteristic of no coagulation of the positive electrode material through electrophoresis, so that the liquid phase and the solid phase are separated. The NMP organic phase with the purity larger than 99% can be obtained through rectification, and the economic value is high. The positive electrode material finally produced by gradient roasting has low organic content and few impurities, is beneficial to subsequent leaching and recycling of valuable metals, and has a great industrial application prospect.

### DETAILED DESCRIPTION

Hereinafter, the concept of the present disclosure and the resulting technical effects will be clearly and completely described with reference to embodiments to fully understand the objectives, features and effects of the present disclosure. Obviously, the described embodiments are only a part of the embodiments of the present disclosure and not all embodiments. Based on the embodiments of the present disclosure, other embodiments obtained by those skilled in the art without involving any inventive effort are within the scope of the present disclosure.

### Embodiment 1

A treatment method of scrapped positive electrode slurry of this embodiment included the following steps:
(1) putting the scrapped positive electrode slurry into an iron basket to separate out bagged materials, and crushing and sorting the bagged materials to obtain a slurry solution;
(2) placing the slurry solution obtained after crushing and sorting into an electrophoresis tank, starting a direct current power source, adjusting a current density to 0.2 A/m² for 30 min of electrophoresis, and performing suction filtration on the slurry to obtain a liquid phase and a solid phase;
(3) performing reduced pressure rotary evaporation on the liquid phase for 60 min under the conditions of a gauge pressure of 0.02 MPa and a temperature of 60° C. to obtain an organic phase and an aqueous phase; and
(4) placing the solid phase into a tube furnace equipped with a condensation gas collecting device, performing roasting for 20 min at 80° C. to remove moisture, then increasing the temperature to 200° C. to continue roasting for 40 min, recycling NMP through condensation, finally, performing roasting for 60 min at 400° C. to remove a binder PVDF, and taking out a positive electrode material after a system was cooled to normal temperature.

The organic phase and the aqueous phase which were obtained after rotary evaporation were analyzed by using a brs-nmp type handheld NMP concentration detector. The concentration of NMP in the organic phase was 83%, and the concentration of NMP in the aqueous phase was 6%. The concentration of the NMP recycled through concentration was 87%.

A solid ignition loss rate of the positive electrode material of this embodiment was 0.29%. An ignition loss rate test method referred to Solid wast-Determination of loss on ignition-Gravimetric method (HJ1024-2019).

### Embodiment 2

A treatment method of scrapped positive electrode slurry of this embodiment included the following steps:
(1) putting the scrapped positive electrode slurry into an iron basket to separate out bagged materials, and crushing and sorting the bagged materials to obtain a slurry solution;
(2) placing the slurry solution obtained after crushing and sorting into an electrophoresis tank, starting a direct current power source, adjusting a current density to 0.5 A/m² for 40 min of electrophoresis, and performing suction filtration on the coagulated slurry to obtain a liquid phase and a solid phase;
(3) performing reduced pressure rotary evaporation on the liquid phase for 60 min under the conditions of a gauge pressure of 0.02 MPa and a temperature of 60° C. to obtain an organic phase and an aqueous phase; and
(4) placing the solid phase into a tube furnace equipped with a condensation gas collecting device, performing roasting for 20 min at 80° C. to remove moisture, then increasing the temperature to 200° C. to continue roasting for 40 min, recycling NMP through condensation, finally, performing roasting for 60 min at 400° C. to remove a binder PVDF, and taking out a positive electrode material after a system was cooled to normal temperature.

The organic phase and the aqueous phase which were obtained after rotary evaporation were analyzed by using a brs-nmp type handheld NMP concentration detector. The concentration of NMP in the organic phase was 83%, and the concentration of NMP in the aqueous phase was 6%. The concentration of the NMP recycled through concentration was 87%.

A solid ignition loss rate of the positive electrode material of this embodiment was 0.15%. An ignition loss rate test method referred to Solid wast-Determination of loss on ignition-Gravimetric method (HJ1024-2019).

### Embodiment 3

A treatment method of scrapped positive electrode slurry of this embodiment included the following steps:
(1) putting the scrapped positive electrode slurry into an iron basket to separate out bagged materials, and crushing and sorting the bagged materials to obtain a slurry solution;
(2) placing the slurry solution obtained after crushing and sorting into an electrophoresis tank, starting a direct current power source, adjusting a current density to 0.6 A/m² for 40 min of electrophoresis, and performing suction filtration on the coagulated slurry to obtain a liquid phase and a solid phase;
(3) performing reduced pressure rotary evaporation on the liquid phase for 60 min under the conditions of a gauge pressure of 0.02 MPa and a temperature of 80° C. to obtain an organic phase and an aqueous phase; and
(4) placing the solid phase into a tube furnace equipped with a condensation gas collecting device, performing roasting for 20 min at 80° C. to remove moisture, then increasing the temperature to 200° C. to continue roasting for 40 min, recycling NMP through condensation, finally, performing roasting for 60 min at 400° C. to remove a binder PVDF, and taking out a positive electrode material after a system was cooled to normal temperature.

The organic phase and the aqueous phase which were obtained after rotary evaporation were analyzed by using a brs-nmp type handheld NMP concentration detector. The concentration of NMP in the organic phase was 88%, and the concentration of NMP in the aqueous phase was 13%. The concentration of the NMP recycled through concentration was 85%.

A solid ignition loss rate of the positive electrode material of this embodiment was 0.33%. An ignition loss rate test method referred to Solid wast-Determination of loss on ignition-Gravimetric method (HJ1024-2019).

### Embodiment 4

A treatment method of scrapped positive electrode slurry of this embodiment included the following steps:
(1) putting the scrapped positive electrode slurry into an iron basket to separate out bagged materials, and crushing and sorting the bagged materials to obtain a slurry solution;
(2) placing the slurry solution obtained after crushing and sorting into an electrophoresis tank, starting a direct current power source, adjusting a current density to 0.2 A/m² for 60 min of electrophoresis, and performing suction filtration on the coagulated slurry to obtain a liquid phase and a solid phase;
(3) performing reduced pressure rotary evaporation on the liquid phase for 30 min under the conditions of a gauge pressure of 0.01 MPa and a temperature of 80° C. to obtain an organic phase and an aqueous phase; and
(4) placing the solid phase into a tube furnace equipped with a condensation gas collecting device, performing roasting for 20 min at 80° C. to remove moisture, then increasing the temperature to 200° C. to continue roasting for 40 min, recycling NMP through condensation, finally, performing roasting for 60 min at 400° C. to remove a binder PVDF, and taking out a positive electrode material after a system was cooled to normal temperature.

The organic phase and the aqueous phase which were obtained after rotary evaporation were analyzed by using a brs-nmp type handheld NMP concentration detector. The concentration of NMP in the organic phase was 81%, and the concentration of NMP in the aqueous phase was 7%. The concentration of the NMP recycled through concentration was 89%.

A solid ignition loss rate of the positive electrode material of this embodiment was 0.42%. An ignition loss rate test method referred to Solid wast-Determination of loss on ignition-Gravimetric method (HJ1024-2019).

### Embodiment 5

A treatment method of scrapped positive electrode slurry of this embodiment included the following steps:
(1) putting the scrapped positive electrode slurry into an iron basket to separate out bagged materials, and crushing and sorting the bagged materials to obtain a slurry solution;
(2) placing the slurry solution obtained after crushing and sorting into an electrophoresis tank, starting a direct current power source, adjusting a current density to 0.2 A/m² for 60 min of electrophoresis, and performing suction filtration on the coagulated slurry to obtain a liquid phase and a solid phase;
(3) rectifying the liquid phase to obtain an organic phase and an aqueous phase, wherein pH of the liquid phase is 7.0-10.0, pressure of an evaporation pot is 7.5 kPa, a reflux ratio was 2.5.
(4) placing the solid phase into a tube furnace equipped with a condensation gas collecting device, performing roasting for 30 min at 80° C. to remove moisture, then increasing the temperature to 200° C. to continue roasting for 40 min, recycling NMP through condensation, finally, performing roasting for 60 min at 400° C. to remove a binder PVDF, and taking out a positive electrode material after a system was cooled to normal temperature.

The organic phase and the aqueous phase which were obtained after rectification were analyzed by using a brs-nmp type handheld NMP concentration detector. The concentration of NMP in the organic phase was 99.5%, and the concentration of NMP in the aqueous phase was 1.2%. The concentration of the NMP recycled through concentration was 88%.

A solid ignition loss rate of the positive electrode material of this embodiment was 0.33%. An ignition loss rate test method referred to Solid wast-Determination of loss on ignition-Gravimetric method (HJ1024-2019).

### Embodiment 6

A treatment method of scrapped positive electrode slurry of this embodiment included the following steps:
(1) putting the scrapped positive electrode slurry into an iron basket to separate out bagged materials, and crushing and sorting the bagged materials to obtain a slurry solution;
(2) placing the slurry solution obtained after crushing and sorting into an electrophoresis tank, starting a direct current power source, adjusting a current density to 0.2 A/m² for 60 min of electrophoresis, and performing suction filtration on the coagulated slurry to obtain a liquid phase and a solid phase;
(3) performing reduced pressure rotary evaporation on the liquid phase for 30 min under the conditions of a gauge pressure of 0.01 MPa and a temperature of 80° C. to obtain an organic phase and an aqueous phase; and
(4) placing the solid phase into a tube furnace equipped with a condensation gas collecting device, performing roasting for 60 min at 100° C. to remove moisture, then increasing the temperature to 220° C. to continue roasting for 30 min, recycling NMP through condensation, finally, performing roasting for 30 min at 400° C. to remove a binder PVDF, and taking out a positive electrode material after a system was cooled to normal temperature.

The organic phase and the aqueous phase which were obtained after rotary evaporation were analyzed by using a brs-nmp type handheld NMP concentration detector. The concentration of NMP in the organic phase was 85%, and the concentration of NMP in the aqueous phase was 6%. The concentration of the NMP recycled through concentration was 87%.

A solid ignition loss rate of the positive electrode material of this embodiment was 0.36%, and energy consumption was 0.38 kwh.

### Comparative Example 1

A treatment method of scrapped positive electrode slurry of this Comparative Example included the following steps:
putting the scrapped positive electrode slurry into an iron basket to separate out bagged materials, and crushing and sorting the bagged materials to obtain a slurry solution;
placing the slurry solution obtained after crushing and sorting into an electrophoresis tank, starting a direct current power source, adjusting a current density to 0.2 A/m² for 60 min of electrophoresis, and performing suction filtration on the coagulated slurry to obtain a liquid phase and a solid phase;
performing reduced pressure rotary evaporation on the liquid phase for 30 min under the conditions of a gauge pressure of 0.01 MPa and a temperature of 80° C. to obtain an organic phase and an aqueous phase; and
placing the solid phase into a tube furnace equipped with a condensation gas collecting device, performing roasting for 120 min at 400° C. to remove moisture, and taking out a positive electrode material after a system was cooled to normal temperature.

A solid ignition loss rate of this Comparative Example was 0.36%, and energy consumption was 0.51 kwh. No independent NMP organic phase was produced in the roasting process.

In conclusion, the present disclosure recycles the scrapped positive electrode slurry by creatively combining the crushing, sorting, electrophoresis and gradient roasting processes. Liquid-solid separation is thorough, and an NMP organic phase can be directly obtained. The economic value is high, and the organic content of the produced positive electrode material is low. The concentration of NMP in either the organic phase recycled through condensation or the organic phase in the rotary evaporation/rectification process is larger than 80%, and an ignition loss rate of the positive electrode material is smaller than 0.5%.

The embodiments of the present disclosure are described in detail above, the present disclosure is not limited to the embodiments described above and various changes can be made without departing from the scope of the present disclosure within the range of knowledge of those of ordinary skill in the art. Furthermore, the embodiments of the present disclosure and features in the embodiments may be combined with one another if there is no conflict.

1. A treatment method of scrapped positive electrode slurry, comprising the following steps:
(1) pretreating the scrapped positive electrode slurry to obtain a slurry solution;
(2) performing electrophoresis coagulation and filter pressing on the slurry solution to obtain a liquid phase and a solid phase; and
(3) performing gradient roasting on the solid phase to obtain a positive electrode material;
wherein in the step (1), the pretreating comprises the specific steps: separating out bagged materials from the scrapped positive electrode slurry, and crushing and sorting the bagged materials to obtain the slurry solution;
wherein in the step (2), a direct current used in the process of performing electrophoresis coagulation has a current of 50-70 mA and a voltage of 60-65 V, the direct current used in the process of performing electrophoresis coagulation has a current density of 0.2-0.6 A/m², and a time of the electrophoresis in the step (2) is 20-60 min; and
wherein in the step (3), a specific process of the gradient roasting is roasting the solid phase at three stages, wherein first-stage roasting is performed at 80-100° C. for 20-60 min, second-stage roasting is performed at 200-250° C. for 30-60 min, and third-stage roasting is performed at 350-450° C. for 30-60 min, so as to obtain the positive electrode material, and the treatment method further comprising, after the second-stage roasting, condensing gas obtained by roasting, and recycling NMP.

2. (canceled)

3. (canceled)

4. (canceled)

5. (canceled)

6. The treatment method of claim 1, wherein the step (2) further comprises performing distillation on the liquid phase, and enriching an organic phase to obtain NMP with a purity larger than 70%.

7. The treatment method of claim 6, wherein the distillation is reduced pressure rotary evaporation or rectification.

8-18. (canceled)
